(19) United States
(12) Patent Application Publication
(10) Pub. No.: US 2004/0143549 A1
(43) Pub. Date: Jul. 22, 2004

(54) Prepaid internet printing protocol (IPP) card and system and method for paying for IPP services

(76) Inventor: George Likourezos, Brooklyn, NY (US)

Correspondence Address: George Likourezos, Esq., 9321 Ridge Boulevard, Brooklyn, NY, 11209, US

(21) Appl. No.: 10/716,717

(22) Filed: Nov. 19, 2003

Related U.S. Application Data
(60) Provisional application No. 60/427,600, filed on Nov. 19, 2002.

(51) Int. Cl. G06F 17/60

(52) U.S. Cl. 705/40

(57) ABSTRACT

A prepaid Internet Printing Protocol (IPP) card to be used for paying for IPP services is provided. A system and method are also provided for paying for IPP services, either by using or not using the prepaid IPP card. The prepaid IPP card is pre-assigned with an amount of monetary funds. The prepaid IPP card can also be pre-assigned a number of tokens, where each token is worth a predetermined amount. The value of the monetary amount of funds or the number of tokens assigned to the prepaid IPP card is displayed on at least one side of the card, along with the selling price of the card. On one side of the prepaid IPP card, the prepaid IPP card has a unique identification code. The unique identification code is used for identifying the prepaid IPP card when print or other services are requested via the Internet or other network.

### PRIORITY

This application claims priority to a U.S. Provisional Application filed on Nov. 19, 2002 titled “Prepaid Internet Printing Protocol (IPP) Card and System and Method for Paying for IPP Services” and assigned U.S. Provisional Application Serial No. 60/427,600, the contents of which are incorporated herein by reference.

### BACKGROUND OF THE INVENTION

1. Field of the Invention

The present invention is directed to a prepaid Internet Printing Protocol (IPP) card and system and method for paying for IPP services.

2. Description of the Related Art

Internet Printing is the application of Internet tools, programs, servers and networks to allow end-users to print to a remote printer using, after initial setup or configuration, the same methods, operations and paradigms as would be used for a locally attached or a local area network attached printer. This could include the use or HTTP servers and browsers and other applications for providing static, dynamic and interactive printer locating services, user installation, selection, configuration, print request or job submission, printer capability inquiry and status inquiry of remote printers and jobs.

The Internet Printing Protocol (IPP) is a standard for submitting and managing print requests or jobs over intranets and the Internet. Key features of IPP are the ability to poll a printer to ask about its availability and properties. To function, an IPP printer requires a Universal Resource Identifier (URL), which is typically a URL, including an IP address. IPP does not provide methods for paying for IPP services when a customer uses the IPP standard to print to a vendor's printer.

Accordingly, it is an object of the present invention to provide a prepaid IPP card to be used primarily for the payment of IPP services. It is also an object of the present invention to provide a system and method for paying for IPP services with or without the use of the prepaid IPP card.

### SUMMARY OF THE INVENTION

The objects of the present invention are achieved by a prepaid IPP card for paying for IPP services. The present invention also provides a system and method for paying for IPP services, either by using or not using the prepaid IPP card. The prepaid IPP card is packaged for being sold or distributed to a customer via a variety of distribution channels, such as retail stores, vending machines, snail mail, etc. The customer can use the prepaid IPP card to pay for IPP services and other services in accordance with the system and method of the present invention.

The prepaid IPP card is pre-assigned with an amount of monetary funds, e.g., US$100.00, and preferably sells for the same amount. The prepaid IPP card can also be pre-assigned a number of tokens, e.g., 1000 tokens, where each token is worth a predetermined amount, e.g., each token is equivalent to US$0.20. Therefore, in the previous example, the prepaid IPP card is worth US$200.00 and would preferably sell for this amount. Each token is also equivalent to a predetermined amount of printed sheets, e.g., one token is equivalent to ten sheets printed on one side or five sheets printed on both sides. That is, one token allows one to have ten sheets printed on one side or five sheets on both sides by a remote printer via the IPP standard. Each token also equals a predetermined amount of printing services, e.g., one token allows one to have ten printed sets stapled, 60 tokens allows one to have ten printed sets bound each having up to thirty sheets, etc. It is contemplated that the prepaid IPP card is pre-assigned with both an amount of monetary funds and tokens and the customer communicates to the system of the present invention whether to deduct monetary funds, tokens, or a combination of both to effect payment for a print request via the IPP standard and/or other service.

The value of the monetary amount of funds or the number of tokens assigned to the prepaid IPP card is displayed on at least one side of the card, along with the selling price of the card. The prepaid IPP card can also display various printing charges or the number of tokens equivalent for various services, such as US$0.05 per non-color printed sheet, US$0.15 per color printed sheet, US$0.005 per staple, one token for printing ten sheets on one side, one token for stapling ten printed sets, etc.

On one side of the prepaid IPP card, the prepaid IPP card has a unique identification code hidden by a peel-off strip of paper, plastic or other material. The unique identification code can also be hidden by packaging material, such as plastic or cardboard. The unique identification code can also be hidden by a layer of scratch-off material. The unique identification code is used for identifying the prepaid IPP card when print or other services are requested via the Internet or other network.

### BRIEF DESCRIPTION OF THE DRAWINGS

FIG. 1 is font view of an exemplary prepaid IPP card in accordance with the present invention; and

FIG. 2 is a back view of the exemplary prepaid IPP card in accordance with the present invention.

### DETAILED DESCRIPTION OF THE PREFERRED EMBODIMENTS

A web browser is software available from a number of sources including but not limited to the following: Microsoft Internet Explorer, NCSA Mosaic, Netscape Navigator, and Sun Hot Java! The major task of these products is to use Hypertext Transport Protocol (HTTP) to retrieve, interpret and display Hypertext Markup Language (HTML). These products are often a part of a complete Internet Printing system, similarly to the system of the present invention, because they are often used as a means of obtaining the status of or more information about the remote printing system.

“Printer” shall be interpreted to include any wireless or non-wireless device which is capable of marking on a piece of media using any available technology. The customer (end-user) computer or client computer is installed with a driver. Driver refers to the code installed in the client operating system to generate the print data stream for the intended remote printer.

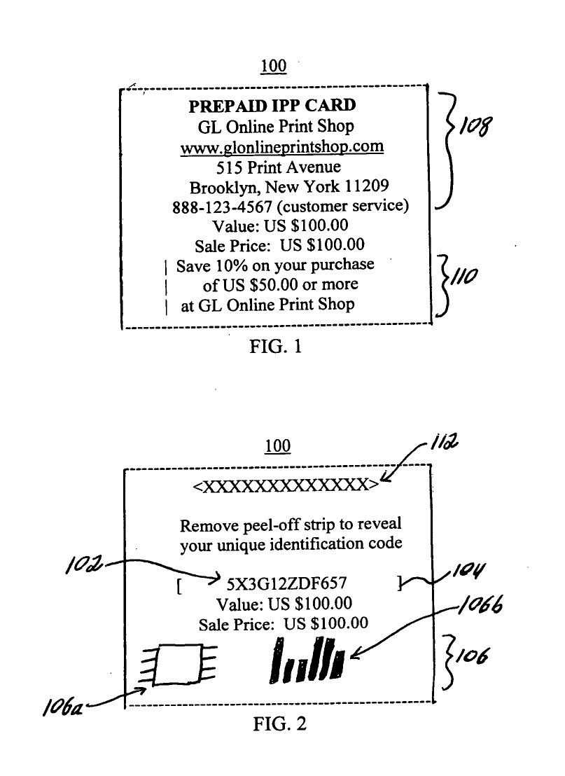

The present invention provides a prepaid Internet Printing Protocol (IPP) card as shown by FIGS. 1 and 2 and designated generally by reference numeral 100. The present invention also provides a system and method for paying for IPP services, either by using or not using the prepaid IPP card 100. The prepaid IPP card 100 is packaged for being sold or distributed to a customer via a variety of distribution channels, such as retail stores, vending machines, snail mail, etc. The customer can use the prepaid IPP card 100 to pay for IPP services and other services in accordance with the system and method of the present invention.

The prepaid IPP card 100 is pre-assigned with an amount of monetary funds, e.g., US$100.00, and preferably sells for the same amount. The prepaid IPP card 100 can also be pre-assigned a number of tokens, e.g., 1000 tokens, where each token is worth a predetermined amount, e.g., each token is equivalent to US$0.20. Therefore, in the previous example, the prepaid IPP card 100 is worth US$200.00 and would preferably sell for this amount. Each token is also equivalent to a predetermined amount of printed sheets, e.g., one token is equivalent to ten sheets printed on one side or five sheets printed on both sides. That is, one token allows one to have ten sheets printed on one side or five sheets on both sides by a remote printer via the IPP standard. Each token also equals a predetermined amount of printing services, e.g., one token allows one to have ten printed sets stapled, 60 tokens allows one to have ten printed sets bound each having up to thirty sheets, etc. It is contemplated that the prepaid IPP card 100 is pre-assigned with both an amount of monetary funds and tokens and the customer communicates to the system of the present invention whether to deduct monetary funds, tokens, or a combination of both to effect payment for a print request via the IPP standard and/or other service.

The value of the monetary amount of funds or the number of tokens assigned to the prepaid IPP card 100 is displayed on at least one side of the card, along with the selling price of the card as shown by FIGS. 1 and 2. The prepaid IPP card 100 can also display various printing charges or the number of tokens equivalent for various services, such as US$0.05 per non-color printed sheet, US$0.15 per color printed sheet, US$0.005 per staple, one token for printing ten sheets on one side, one token for stapling ten printed sets, etc.

On one side of the prepaid IPP card 100, the prepaid IPP card 100 has a unique identification code 102 hidden by a peel-off strip of paper, plastic or other material 104. The unique identification code 102 can also be hidden by packaging material, such as plastic or cardboard. The unique identification code 102 can also be hidden by a layer of scratch-off material. The unique identification code 102 is used for identifying the prepaid IPP card 100 when print or other services are requested via the Internet or other network as further described below. In FIG. 2, the unique identification code 102 is shown as a phantom view through the covering material 104 for illustration purposes.

The prepaid IPP card 100 can also include a computer-readable medium 106, such as a magnetic stripe (data-encoded strip), computer chip, bar code, radio frequency identification (RFID) tag, a compact-disc type surface encoding digital data, etc., or a combination thereof as shown in FIG. 2 (computer chip 106a and bar code 106b). The computer-readable medium 106 preferably stores or represents data corresponding or indicative of the prepaid IPP card 100, such as the unique identification code 102; the value of the monetary amount of funds and/or the number of tokens assigned to the prepaid IPP card 100; the value of a list of printing services; such as the cost of printing a single-sided sheet/double-sided sheet/colored sheet/etc.; etc.

The computer-readable medium 106 can be read by a computer-readable device, such as a bar code scanner, optical disc reader, scanner, etc., and the data stored or represented by the computer-readable medium 106 can be processed and communicated to the remote computing device or printer. The data can also be uploaded to the web site corresponding to the system of the present invention for viewing by the customer, such as by accessing a “MY IPP ACCOUNT” web page as described below. The customer can also use a stand-alone computer-readable device having a display for viewing data stored by the prepaid IPP card 100 without having to access the Internet. Such data can include a table indicating the amount of funds or tokens needed for specific IPP services, such as copying, stapling, and delivering the printed job. It is contemplated that data stored by some types of the computer-readable medium, such as a data-encoded strip, can be appended or overwritten by data transmitted by the system of the present invention.

It is contemplated that the prepaid IPP card 100 can be in the form of a smart memory card, such as a PMCIA card, configured and dimensioned for inserting within a slot of a computing device configured for reading data stored within smart memory cards and transmitting said data to a remote computing device. The computing device is also configured for writing data to the smart prepaid IPP memory card.

As noted above, the prepaid IPP card 100 can be sold at a retail store, such as Kinko's™, Staples™, and Office Depot™. As such, the prepaid IPP card 100 can display information 108 relating to the retail store, such as the retail store's name, logo, location, customer service number, URL address, etc., on at least one side of the card. The customer can also go to the retail store displayed on the prepaid IPP card 100 or other retail establishment to have his prepaid IPP card 100 assigned additional monetary funds or tokens (i.e., a monetary amount) after purchasing additional monetary funds or tokens. At the store, a store employee accesses a database of the system of the present invention, either through the Internet or other network, such as a LAN, WAN, etc., locates the record in a database corresponding to the customer's prepaid IPP card 100 and appends the record by adding the additional monetary finds or tokens to the existing amount of monetary funds or tokens.

The customer can also call the customer service number displayed on the prepaid IPP card 100 or access the web site corresponding to the URL address displayed on the prepaid IPP card 100 for either a customer representative or the customer, respectively, to access the system in accordance with the present invention for assigning additional monetary funds or tokens to his prepaid IPP card 100. The customer can use a credit card, checking account or other account, and/or an online payment service, such as PayPal and Yahoo! Pay Direct, to purchase additional monetary funds or tokens.

It is contemplated that the customer can also configure the system of the present invention either through the customer service representative or the Internet to automatically assign additional monetary funds or tokens to his prepaid IPP card 100 when the amount of monetary funds or the number of tokens fall below a predetermined amount or number. The customer can also indicate to the system the preferred method(s) of payment for automatically assigning additional monetary funds or tokens, such as credit card, checking account or other account, and/or an online payment service, such as PayPal and Yahoo! Pay Direct.

The prepaid IPP card 100 can also display a coupon 110 on at least one side which the customer can present at the retail store or other retail establishment, after depleting the prepaid funds or tokens assigned to the prepaid IPP card 100, to realize savings on the purchase of a particular item and/or on an overall purchase, e.g., 10% off the overall purchase. The coupon 110 thus facilitates the customer to return the depleted prepaid IPP card 100 to a retail store. The depleted prepaid IPP card 100 can then be recycled by the retail store assigning additional monetary funds or tokens to the depleted prepaid IPP card 100, package the prepaid IPP card 100, and resale the prepaid IPP card 100.

The prepaid IPP card 100 can also display a hologram 112 to stifle or prevent counterfeiting of the prepaid IPP card 100.

As further described below with reference to the system and method of the present invention, the unique identification code 102 of the prepaid IPP card 100 is transmitted to a remote computing device, such as a server, or printer of the system of the present invention to facilitate and initiate an IPP print request or other service. After receiving the unique identification code 102, the remote computing device or printer determines if the prepaid IPP card 100 corresponding to the transmitted unique identification code 102 has sufficient monetary funds or tokens to cover for charges associated with the IPP print request and/or other print-related service request(s), such as stapling, binding, hole-punching, packaging, shipping, etc.

If yes, the IPP print request and/or other print-related service request(s) is performed and the monetary funds or tokens assigned to the customer's prepaid IPP card 100 are subtracted accordingly. If no, the IPP print request and/or other print-related service request(s) is not performed and the customer or end-user is informed by a pop-up window and/or by an e-mail. The pop-up window and/or e-mail preferably include a link to a web site where the customer can add additional monetary funds or tokens to his prepaid IPP card 100. The customer can then indicate to the system to proceed with the IPP print request and/or other print-related service request(s).

For security purposes, it is provided that after first transmitting the unique identification code 102 to the remote computing device or printer of the inventive system to initiate an IPP print request via the IPP standard and/or other print-related service request(s), or to access the “MY IPP ACCOUNT” web page as described below, the remote computing device or printer accesses a look-up table or other data structure to determine whether the unique identification code 102 has been previously transmitted to the system of the present invention. If not, the remote computing device or printer of the system preferably transmits to the customer a request to enter and transmit a unique username and password.

The system then assigns the transmitted unique username and password to the unique identification code 102 in the look-up table or other data structure. If the unique identification code 102 has been previously received by the remote computing device or printer, the remote computing device or printer requests the customer to enter the unique username and password previously assigned to the unique identification code 102. If the received username and password matches the username and password previously assigned to the unique identification code 102, the IPP print request and/or other print-related service request(s) is processed as described above. That is, the system determines if the customer has sufficient monetary funds or tokens to cover for charges associated with the IPP print request and/or other print-related service request(s), and the method proceeds accordingly.

It is evident that the unique username and password provides an added security measure to the customer if the customer loses his prepaid IPP card 100 before using up all the monetary funds and tokens pre-assigned to the prepaid IPP card 100. That is, anyone who finds the prepaid IPP card 100 would not be able to use the prepaid IPP card 100 without knowing the unique username and password assigned to the unique identification code 102 of the prepaid IPP card 100.

As a further added security measure, the retail store or other establishment provides a computer terminal connected to the remote computing device of the system of the present invention for allowing the customer, after purchasing the prepaid IPP card 100, to transmit the unique username and password to the remote computing device via the Internet or other network, along with the unique identification code 102, in order for the remote computing device to assign the unique username and password to the unique identification code 102. Hence, if the customer loses his prepaid IPP card 100 after leaving the retail store, the customer can still use the monetary funds or tokens assigned to the prepaid IPP card 100 to pay for IPP and other services without actually having physical possession of the prepaid IPP card 100.

Additionally, if the customer loses his prepaid IPP card 100, the customer can call a provider, distributor, manufacturer, customer service representative, or other individual/entity associated with the prepaid IPP card 100, or access the web site of the system of the present invention, provide his unique username and password, and be given or provided with his unique identification code 102 and the amount of monetary funds or tokens still assigned to the prepaid IPP card 100.

It is, however, contemplated that after the customer first transmits the unique identification code 102 assigned to his prepaid IPP card 100 to the remote computing device or printer of the system of the present invention and also transmits his unique username and password to the remote computing device or printer, the customer can thereafter transmit IPP print requests or other service requests to the remote computing device or printer by only entering his unique username and password. Accordingly, the physical possession of the prepaid IPP card 100 or transmission of the unique identification code 102 would not be necessary to use the prepaid IPP card 100 to pay for IPP print services and other services.

The unique username and password can be changed by the customer accessing the web site of the system of the present invention. While in the web site, the customer can access the “MY IPP ACCOUNT” web page associated with the web site by clicking or selecting a hyperlink labeled, for example, “MY IPP ACCOUNT.” Upon clicking or selecting the hyperlink, a pop-up window is displayed with at least one field for inputting the unique username and password. The pop-up window also includes an ENTER icon for clicking or selecting after inputting the unique username and password. The “MY IPP ACCOUNT” web page is then accessed.

While in “MY IPP ACCOUNT” web page, the customer can change his unique username and password, determine the amount of monetary funds or tokens assigned to his prepaid IPP card 100, and assign additional monetary funds or tokens to his prepaid IPP card 100 as described above.

While in “MY IPP ACCOUNT” web page, the customer can also select alternative payment methods to be used if the amount of monetary funds or tokens assigned to his prepaid IPP card 100 (primary method of payment) are used or insufficient to fully effect payment. Alternative payment methods include charging a credit card; debiting a debit card; deducting funds from an account corresponding to the customer, such as a corporate, checking, savings, commercial or other account; deducting funds from an online payment account, such as PayPal, Yahoo! Pay Direct, and Amazon.com Payments account; loaning funds to the customer; and deducting funds from a line of credit. It is contemplated that the use of the prepaid IPP card 100 to effect payment can be selected as an alternative method via the web site, and one or more other payment methods may be selected as the primary method(s) of payment.

Upon selecting one or more alternative payment methods, the customer is provided with at least one payment web page for entering information needed for using the selected methods, such as credit card information, account information, customer's e-mail address for receiving payment requests if an online payment account is selected as an alternative payment method, etc.

If the prepaid IPP card 100 is selected as an alternative payment method, the customer does not need to provide the prepaid IPP card's unique identification code 102, username and password, since this information is known to the system because the customer provided the unique username and password prior to entering the “MY IPP ACCOUNT” web page. The unique identification code 102 can be determined after knowing the unique username and password by using the look-up table or other data structure.

The at least one payment web page also provides fields for entering percentages to be used for allocating to the various selected alternative payment methods. For example, if the customer selects for the system of the present invention to charge his credit card and deduct funds from his PayPal account as alternative payment methods, the at least one payment page requests the customer to enter a percentage of the total price to be charged to his credit card and to enter a percentage of the total price to be deducted from his PayPal account. The percentages should equal 100%.

While in “MY IPP ACCOUNT,” the customer can also provide default settings, such as a preferred remote printer for performing the print request or job; a shipping address for where the printer operator is to ship the printed sheets; select a preferred method of shipping or select whether hand-delivery is desired; indicate a time when the print request should be completed by; indicate a time when the print request can be initiated (after this time, the customer would be responsible for the charges incurred for performing the print request, if the print request is performed; also, after this time, the customer would be charged a cancellation fee, if the customer cancels the print request); etc. The default setting also include print attributes, such as whether to provide a footer or header to be printed on each printed sheet or every x number of sheets; whether the printed sheets are to be bound, collated, hole-punched, stapled and in which position, interleaved with transparencies or colored paper, bate-stamped, rubber-stamped, etc.; what type of paper to be used (redline, bond, resume paper, color paper and which color, color transparencies and which color, etc.);

Upon selecting or clicking on a soft button, e.g., an ENTER or APPLY soft button, the default settings are transmitted via the Internet or other network to the remote computing device or remote printer of the system of the present invention and saved as preferred customer settings. The default settings can also be saved within the customer's computer and transmitted to the remote computing device or remote printer when the customer transmits a print request or other request to the remote computing device or remote printer.

In either method, if the customer has already provided default settings, the newly-transmitted default settings overwrite the previously stored default settings within the remote computing device, remote printer, and/or customer's computer. It is, however, contemplated that the new default settings do not overwrite the previously stored default settings, and both (or plural) default settings are saved. In this scenario, the customer can always access the “MY IPP ACCOUNT” web page and select a preferred set of default settings for a particular computer session, print request, and/or other print-related request(s). The customer can also delete default setting while in “MY IPP ACCOUNT.”

As an added advantage, the default settings enable the system of the present invention to provide IPP printing services and other printing-related services, as well as collect payment for these services, during a computer session (e.g., from the time the customer turns on his computer or logs in until the time the customer turns off his computer or logs out) with only a single action being performed by the customer. For example, after the customer has specified the default settings and transmitted the unique username and password to the remote computing device or remote printer of the present invention, then every time during the computer session that the customer selects or clicks a print function or print icon on his web browser; application software, such as MS WORD and WORDPERFECT; etc., the system of the present invention executes a series of programmable instructions for automatically transmitting the print request and default settings (if the default settings have not been already transmitted) to the specified preferred remote printer. The remote printer then performs the print request by printing a specific document(s) (or the document currently displayed by the web browser, application software, etc.) and for automatically effecting payment for performing the print request by subtracting monetary funds or tokens assigned to the prepaid IPP card 100, and/or by one or more other alternative payment methods as discussed above. The system of the present invention then determines the amount of monetary funds or tokens available for the prepaid IPP card 100 and stores the remaining funds or tokens in the look-up table or other data structure in a record corresponding to the unique identification code 102.

Accordingly, as illustrated above as an example with reference to default settings, the system of the present invention can use the monetary funds or tokens assigned to the prepaid IPP card 100 to also pay for other printing-related charges, e.g., stapling charges, binding charges, collating charges, hole-punching charges, bate-stamping charges, rubber-stamping charges, shipping charges, hand-delivering charges, etc. It is, however, provided that the prepaid IPP card 100 can be used to pay for these printing-related charges outside the context of default settings, i.e., without specifying these options as default settings.

It is further provided that the prepaid IPP card 100 can be used to pay for printing charges and other printing-related charges by communicating the unique identification code 102, unique username, and/or unique password to the system of the present invention over one or more other networks besides the Internet, such as the PSTN, a wireless network, a cellular network, a paging network, a satellite-based network, etc. These networks may or may not connect to the Internet to route the information.

For example, before or after transmitting the print request and/or other printing-related request(s) to the remote computing device or remote printer via the IPP standard, the customer can telephone a customer service representative at the location of where the print request and/or other printing-related request(s) is to be satisfied or another location and provide the customer service representative with payment information to be used for effecting payment for the print request and/or other printing-related request(s). The payment information can include one or more of the following: information corresponding to the customer's prepaid IPP card 100, such as the unique identification code 102, unique username, and/or unique password corresponding to the customer's prepaid IPP card 100; credit card information; debit card information; online payment account information; line of credit information; authorization to loan funds; details of the print request or other request; etc.

After verifying the payment information, the customer service representative provides the customer with the total amount of funds (or tokens) required to effect payment. After the total is approved by the customer, then in the case where the customer indicated payment using his prepaid IPP card 100, the customer service representative accesses the look-up table or other data structure of the system of the present invention, subtracts the amount of funds (or tokens) corresponding to the customer's prepaid IPP card 100, and stores the remaining amount of funds (or tokens) within the look-up table or other data structure. The customer can then view the remaining amount of funds (or tokens) by accessing the web site corresponding to the system of the present invention and accessing “MY IPP ACCOUNT” web page.

The prepaid IPP card 100, method and system of the present invention can also be used to pay for non-IPP and non-printing-related charges, such as paying for telephone call charges and paying for Internet access charges. In such cases, the unique identification code 102 and/or other information provided on or associated with the prepaid IPP card 100 can be used to pay for these other non-IPP and non-printing-related charges, such as telephone call charges and Internet access charges. Hence, the prepaid IPP card 100 of the present invention can be marketed, distributed, and used for paying charges associated with multiple services. For example, to pay for IPP print request charges and/or other printing-related request(s) charges, telephone charges and/or Internet access charges.

One method of operation in accordance with the method and system of the present invention will now be described with respect to using the prepaid IPP card 100 to pay for IPP services. While connected to the Internet or other network, the customer transmits a print request or job via the web browser to the remote computing device or printer to have a document printed. The print request is processed and transmitted by IPP end-user application software executed by the customer's computer.

As mentioned above, the print request can include various print attributes, such as the amount of sets to be printed; whether to staple the printed document(s); whether to bind the document(s); whether to hole-punch the document(s); whether to bate-stamp/rubber-stamp the document(s); whether to include a footer/header on the printed document(s), such as page numbers; whether to enlarge/reduce the transmitted document prior to printing; whether to interleave transparencies or blank sheets of paper within the document(s); and whether to rotate by a pre-selected number of degrees the document(s). The print request can further include special instructions, such as a shipping address for where the printer operator is to ship the printed sheets; a preferred method of shipping, such as hand-delivery, or whether the printed document(s) would be picked-up; a time when the print request should be completed by; and a time when the print request can be initiated (after this time, the customer would be responsible for the charges incurred for performing the print request, if the print request is performed; also, after this time, the customer would be charged a cancellation fee, if the customer cancels the print request).

The remote computing device or printer receives the print request in the form of a print request signal or digital data stream. Upon receiving the print request signal, the remote printer or server accesses and executes application software. The application software instructs the customer via a pop-up window on the web browser and/or by e-mail to transmit the unique username and password. The application software after receiving the unique username and password, determines whether the unique username and password corresponds to a user of the system. If no, the application software requests the customer to retransmit the unique username and password. At this point, the customer can retransmit the unique username and password or terminate the method. If yes, the application software processes the print request signal to determine the print job and the print job's associated print attributes and/or special instructions.

The application software then determines using a look-up table or other data structure of the system of the present invention the total amount due from the customer to process/perform the print request and/or other services. The amount due, a synopsis of the print request, a request to confirm or cancel the print request, and a request for additional information, if additional information is needed, are then communicated to the customer via a pop-up window and/or e-mail.

The remote computing device or printer then receives a signal indicating the selection made by the customer and, if applicable, a response to the request for additional information. If the customer cancelled the print request, the method terminates. If the customer confirmed the print request, a payment page is displayed and the customer via the payment page selects at least one of several displayed options for paying for the IPP services, the additional services (e.g., stapling, binding, hole-punching, etc.) and the delivery charges (if applicable). The options can include paying using funds or tokens allocated to the prepaid IPP card 100, paying using a credit card, paying by using funds in a direct deposit account (e.g., checking and savings accounts), paying using funds in a commercial account, paying using an online payment service, such as Yahoo! Pay Direct and PayPal, where a plurality of online payment accounts are maintained by a database system.

The plurality of online payment accounts are configured for receiving funds from a source account and for transferring funds to a destination account upon receiving directions from the customer. It is contemplated for the customer to configure his online payment account to automatically receive funds from the source account and to automatically transfer funds to the destination account for automatically paying for the various IPP and non-IPP services detailed herein.

If the customer selects to pay using a prepaid IPP card 100, the remote computing device or printer requests from the customer to transmit either the unique identification code 102 corresponding to his prepaid IPP card 100 or his unique username and password.

The customer transmits the unique identification code 102 or unique username and password to the remote computing device or printer and the remote printer or server (i.e., a remote processor therein) accesses a look-up table or other data structure to determine the amount of monetary funds or tokens corresponding to the prepaid IPP card 100 having the received unique identification code 102 or unique username and password. If the amount of monetary funds or tokens is sufficient to pay the predetermined total amount, the print request is then performed. The printed document(s) are then processed according to the print request (and any default settings) and either shipped, hand-delivered, or held for customer pick-up. If the amount of monetary funds or tokens is not sufficient to pay the predetermined total amount, the customer is informed of this fact via the Internet and given the opportunity to add additional monetary funds or tokens to his prepaid IPP card 100, using one of the payment methods listed above, or given the opportunity to use at least one other payment method listed above. It is contemplated that the operator of the remote computing device or printer, or a financial institution affiliated with the operator, loans funds to the customer for paying at least a portion of the total amount due.

What is claim is:

1. An Internet Printing Protocol (IPP) payment system for paying for IPP services, said system comprising:
a plurality of IPP cards;
a data structure storing a plurality of records, where each record includes an identification code and a monetary amount, and where each record corresponds to one of the plurality of IPP cards; and
a processor for determining if the monetary amount corresponding to one of the plurality of IPP cards is sufficient for the payment of an IPP service.

2. The IPP payment system according to claim 1, wherein the plurality of IPP cards are prepaid.

3. The IPP payment system according to claim 1, wherein the processor includes means for receiving instructions to deduct or add an amount from or to a monetary amount corresponding to one of the plurality of records via a network.

4. The IPP payment system according to claim 1, wherein the processor determines if the corresponding monetary amount corresponding to one of the plurality of IPP cards is sufficient for the payment of a non-IPP service.

5. The IPP payment system according to claim 1, wherein each of the plurality of IPP cards corresponds to a subscriber of said IPP payment system.

6. An IPP card comprising a front face and a back face, wherein at least one of said faces indicates at least a monetary amount associated with said IPP card and identification indicia for transmitting via a network to a remote processor for said remote server to identify said IPP card and to determine a monetary amount associated with said IPP card, wherein said monetary amount may differ from the monetary amount indicated on the at least one of said faces.

7. The IPP card according to claim 6, wherein said IPP card is prepaid.

8. The IPP card according to claim 6, wherein at least one of said faces includes a coupon.

9. The IPP card according to claim 6, wherein at least one of said faces includes at least one of the following: a magnetic stripe, computer chip, bar code, radio frequency identification (RFID) tag, a compact-disc type surface encoding digital data, and a hologram.

10. The IPP card according to claim 6, further comprising a computer-readable medium storing data.

11. The IPP card according to claim 10, wherein said data includes a unique identification code assigned to said IPP card; the value of the monetary amount assigned to the IPP card; and a monetary amount for specific IPP services.

12. The IPP card according to claim 6, wherein the IPP card is a smart memory card configured for insertion within a reading device.
